(19) United States
(12) Patent Application Publication
(10) Pub. No.: US 2020/0037583 A1
(43) Pub. Date: Feb. 6, 2020

(54) LIGHTING SYSTEM FOR AVIAN ENCLOSURES

(71) Applicant: SIGNIFY NORTH AMERICA CORPORATION, SOMERSET, NJ (US)

(72) Inventor: ZDENKO GRAJCAR, ORONO, MN (US)

(21) Appl. No.: 16/496,772

(22) PCT Filed: Mar. 21, 2018
(86) PCT No.: PCT/US2018/023535

§ 371 Date: Sep. 23, 2019

Related U.S. Application Data
(60) Provisional application No. 62/475,419, filed on Mar. 23, 2017.
(60) Provisional application No. 62/623,257, filed on Jan. 29, 2018.

(51) Int. Cl. A01K 31/22; A01K 31/18; A01K 29/00

(52) U.S. Cl. CPC A01K 31/22; F21V 9/08; A01K 29/00; A01K 31/18

(57) ABSTRACT

Methods and systems that provide light sources in various areas of an animal enclosure to encourage or discourage animal behaviors. Different wavelengths or intensities of light are provided in various areas of the enclosure such that the animals, for example avian, in the enclosure are encouraged to occupy or not occupy the various areas. Lighting schedules for individual areas can be off-set from one another to encourage movement of the animals to different levels and preventing grouping or piling of the animals from occurring. The lighting schedules can be such that desirable or undesirable wavelengths or intensities of light, as perceived by the animals, are provided to different areas or levels at random times and for random durations during a day. Thus, the animal movement around the enclosure during the day is encouraged, clustering of animals in a single area is discouraged, and the welfare of the animals is improved.

### CLAIM OF PRIORITY

This patent application claims the benefit of priority of U.S. Provisional Patent Application Ser. No. 62/475,419, entitled “LIGHTING SYSTEM FOR CAGE FREE SYSTEM,” filed on Mar. 23, 2017, and U.S. Provisional Patent Application Ser. No. 62/623,257, entitled “LIGHTING SYSTEM FOR AVIAN CAGE SYSTEM,” filed on Jan. 29, 2018, the benefit of priority of each of which is claimed hereby, and each of which are incorporated by reference herein in its entirety.

### BACKGROUND

Specially designed cages are used to house chicken, poultry, or other animals in egg production facilities. The cages include systems for automatically retrieving eggs laid by the animals. The automatic retrieval of the eggs minimizes manual labor costs, while the prompt removal of eggs from the cages ensures that the eggs remain clean and intact (not broken), and that the eggs can be cooled or otherwise processed without delay.

In cage-free facilities, the chicken, poultry, or other animals are free to move around enclosures within the facility. The enclosures generally include nests or other areas specially designed for laying eggs, and systems for automatically retrieving eggs from the nests. However, since the animals can move around the enclosures freely, the animals also lay eggs in non-nest areas within the enclosures. Another problem with the cage free systems is that birds tend to all migrate to similar levels or locations within the cage free system. For example, at night birds have been known to gather on the top level of the cage free system. This creates multiple issues, including but not limited to piling of avian species which can lead to deaths in a flock, lack of movement of the birds, overloading of eggs on the conveyor, and the like.

### SUMMARY

The present inventors have recognized, among other things, that a need in the art exists to minimize gathering of birds in any one area or level of an enclosure. The present subject matter can help provide a solution to this problem, such as by providing lighting sources in various areas of an animal enclosure that encourages animals in the enclosure to occupy or not occupy the various areas, and move around the enclosure which can promote the animals' welfare. Different wavelengths or intensities of light are provided in various areas of the enclosure such that the animals in the enclosure are encouraged to occupy or not occupy the various areas. Lighting schedules for individual areas can be off-set from one another to encourage movement of the animals to different levels and preventing grouping or piling of the animals from occurring.

Aspect 1 can include or use subject matter (such as an apparatus, a system, a device, a method, a means for performing acts, or a device readable medium including instructions that, when performed by the device, can cause the device to perform acts), such as can include emitting a UV light in a first area of an enclosure where the avian species is wanted, the UV light being desirable to the avian species; and emitting a light having a wavelength undesirable to the avian species in a second area of the enclosure where the avian species is not wanted.

Aspect 2 can include or use, or can optionally be combined with the subject matter of Aspect 1, to optionally include wherein the UV light is in a range of 340 nm to 430 nanometers (nm).

Aspect 3 can include or use, or can optionally be combined with the subject matter of one or any combination of Aspects 1 or 2 to optionally include wherein the light having the wavelength undesirable to avian species is a bright light in a range of 100 to 50,000 Galli-lux as experienced by the avian species.

Aspect 4 can include or use, or can optionally be combined with the subject matter of one or any combination of Aspects 1 through 3 to optionally include wherein the light having the wavelength undesirable to avian species includes a blue light.

Aspect 5 can include or use, or can optionally be combined with the subject matter of one or any combination of Aspects 1 through 4, to optionally include wherein the light having the wavelength undesirable to avian species is in a range of 430 nm to 500 nm.

Aspect 6 can include or use, or can optionally be combined with the subject matter of one or any combination of Aspects 1 through 5, to optionally include

Aspect 7 can include or use, or can optionally be combined with the subject matter of one or any combination of Aspects 1 through 6, to optionally include non-synchronously alternating an intensity of the UV light and the light having the wavelength undesirable to the avian species in the second area of the enclosure.

Aspect 8 can include or use, or can optionally be combined with the subject matter of one or any combination of Aspects 1 through 7, to optionally include transitioning from emitting the UV light in the first area of the enclosure to emitting the UV light in a third area of the enclosure.

Aspect 9 can include or use, or can optionally be combined with the subject matter of one or any combination of Aspects 1 through 8, to optionally include transitioning from emitting the light having the wavelength undesirable to the avian species in the second area of the enclosure to emitting the light having the wavelength undesirable to the avian species in a third area.

Aspect 10 can include or use, or can optionally be combined with the subject matter of one or any combination of Aspects 1 through 7, to optionally include transitioning from emitting the UV light in the first area of the enclosure to emitting the UV light in the second area of the enclosure; and transitioning from emitting the light having the wavelength undesirable to the avian species in the second area of the enclosure to emitting the light having the wavelength undesirable to the avian species in the first area; wherein the transitions are performed at random times during a day.

Aspect 11 can include or use, or can optionally be combined with the subject matter of one or any combination of Aspects 1 through 10, to optionally include emitting a red light in the first area or the second area.

Aspect 12 can include, or can optionally be combined with the subject matter of one or any combination of Aspects 1 through 11 to include or use, subject matter (such as an apparatus, a method, a means for performing acts, or a machine readable medium including instructions that, when performed by the machine, that can cause the machine to perform acts), such as can include emitting a low intensity red light near an egg laying zone, shielding an interior area of the egg laying zone such that the low intensity red light is only minimally allowed inside the interior area of the egg laying zone; and emitting a UV light in one or more areas where egg laying is not desired.

Aspect 13 can include or use, or can optionally be combined with the subject matter of Aspect 12, to optionally include wherein the low intensity red light has a wavelength in a range of 600 to 700 nanometers (nm).

Aspect 14 can include or use, or can optionally be combined with the subject matter of one or any combination of Aspects 12 or 13 to optionally include wherein the low intensity red light is in a range of 0.1 to 20 Galli-lux as experienced by the avian species.

Aspect 15 can include or use, or can optionally be combined with the subject matter of one or any combination of Aspects 12 through 14, to optionally include wherein UV light has a wavelength in a range of 350 to 400 nm.

Aspect 16 can include or use, or can optionally be combined with the subject matter of one or any combination of Aspects 12 through 15, to optionally include wherein the UV light is in a range of 5 to 100 Galli-lux as experienced by the avian species.

Aspect 17 can include or use, or can optionally be combined with the subject matter of one or any combination of Aspects 12 through 16, to optionally include wherein the interior area of the egg laying zone includes egg laying boxes.

Aspect 18 can include or use, or can optionally be combined with the subject matter of one or any combination of Aspects 12 through 17, to optionally include wherein the areas where egg laying is not desired includes on the floor and areas above the egg laying zone.

Aspect 19 can include or use, or can optionally be combined with the subject matter of one or any combination of Aspects 1 through 18, to optionally include wherein the avian species is chicken.

Aspect 20 can include or use, or can optionally be combined with the subject matter of one or any combination of Aspects 1 through 18, to optionally include wherein the avian species is turkey.

Aspect 21 can include or use, or can optionally be combined with the subject matter of one or any combination of Aspects 1 through 18, to optionally include wherein the avian species is duck.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a cross-sectional view of an enclosure containing an aviary system and having a differential illumination system

FIG. 2 is a flow chart illustrating a method for controlling lighting and illumination in order to provide differential illumination

FIG. 3 shows a cross-sectional view of an enclosure containing an aviary system and having a differential illumination system

FIG. 4 shows a cross-sectional view of an enclosure containing an egg laying zone and having a differential illumination system.

FIG. 5 shows a control system for controlling lighting and illumination produced by a differential illumination system.

FIG. 6 shows a graph of light source intensity over time.

### DETAILED DESCRIPTION

In the following detailed description, numerous specific details are set forth by way of examples in order to provide a thorough understanding of the relevant teachings However, it should be apparent to those skilled in the art that the present teachings can be practiced without such details. In other instances, well known methods, procedures, components, and/or circuitry have been described at a relatively high-level, without detail, in order to avoid unnecessarily obscuring aspects of the present teachings.

Egg production facilities are highly mechanized, and typically include systems for automatically retrieving eggs laid by the chicken, poultry, or other animals promptly after the eggs have been laid. The egg retrieval systems are designed to collect eggs from nests or other areas specially designed for laying eggs. Animals typically like to lay eggs in areas that are dark and closed off. Nesting areas are therefore generally designed to be dark and partially closed off (while still maintaining open access for the animals), so as to encourage animals to lay eggs in them.

Behavioral and physiological studies show that animal behavior is influenced by exposure to light in general, and to specific wavelengths of light in particular. For example, exposure to red light (or to light having a red hue) can increase the growth rate of chickens and turkeys at the beginning of the rearing period, increase locomotion that helps minimize leg disorders in the late rearing period, stimulate and promote sexual activity, and reduce feed consumption per egg laid with no differences in egg size, shell weight, shell thickness, or yolk and albumen weights. However, the exposure to red light (or to light having a red hue) can promote cannibalism in broilers. On the other hand, exposure to green and blue light (or to light having green or blue hues) can significantly enhance the animals' growth rate at an early age by enhancing proliferation of skeletal muscle satellite cells, enhance growth at a later age by elevating plasma androgens (in the case of blue light), promote myofiber growth due to more effective stimulation of testosterone secretion, reduce locomotion (in the case of narrow band blue light), and reduce cannibalism rates at late age in broilers (in the case of narrow band blue light). Alternatively, UV light, light having a wavelength under 400 nanometers (nm), can be used to help entrain the circadian rhythms of an avian, assist in melatonin production and attract avian in general.

Light, and more particularly the color or spectrum of light, can therefore be used to influence the behaviors of animals. As used herein, light generally refers to electromagnetic radiation, and more particularly to radiation having wavelengths in the range of 300 to 800 nm. The human eye is sensitive to radiation having wavelengths in the range of 400 to 700 nm, with a peak of sensitivity at around 550 nm (corresponding to green light). However, domestic fowl are sensitive to a broader range of wavelengths both through their eyes, and through their skulls using receptors located in the pineal gland and in the hypothalamus. In particular, domestic fowl are sensitive to light having wavelengths in the range of 300 to 800 nm. Domestic fowls have peak sensitivities to light having wavelengths of around 380 nm (corresponding to UVA or UV light), around 480 nm (corresponding to blue light), around 570 nm (corresponding to green-yellow light), and around 630 nm (corresponding to red light). As such, this document refers to light as any radiation in a range of 300 to 800 nm to which animals are visually sensitive (e.g., through eyes) or physiologically sensitive (e.g., through other receptors, such as receptors in the pineal gland and hypothalamus), including radiation commonly referred to as ultra-violet (UV) and infrared (IR).

Light can have different spectrums or spectral contents depending on the particular mixture and relative intensity of wavelengths included in the light. For example, white light (such as natural daylight) generally has a spectrum including a mixture of radiations from 300 to 800 nm at relatively similar intensities. Red light (or reddish light) has a spectrum predominantly (or only) including radiation having wavelengths in the “red” range of 635-700 nm (and more generally, wavelengths over 620 nm). Blue light (or bluish light) has a spectrum predominantly (or only) including radiation having wavelengths in the “blue” range of 430-490 nm (and more generally, wavelengths in the range of 400 nm to 500 nm). Green light (or greenish light) has a spectrum predominantly (or only) including radiation having wavelengths in the “green” range of 490-560 nm. UV or UVA light has a spectrum predominately including radiation in the range of 340 nm to 400 nm and, more generally, below 400 nm. A light spectrum predominantly includes radiation of a particular wavelength or range of wavelengths if the relative luminous power (or energy content) of those particular wavelength(s) is higher than the luminous power (or energy content) of other wavelengths in the light spectrum. However, a light that is substantially of a given color can include radiation having a range of wavelengths of the given color, as well as radiation of other wavelengths.

A light source can be operative to produce light having a spectrum substantially concentrated within the specified range or narrow band of wavelength (e.g., 550 nm-570 nm, or other narrow wavelength range) when over 90% or over 95% of the lighting energy emitted by the light source is within the specified narrow range of wavelengths. In some examples, the light source can thus also emit a small amount of light outside of the specified range. For LED's the specified band of wavelength, specific wavelength, or narrow band of wavelength can refer to the wavelength at which the LED emits maximum spectral power. Other lights and spectral outputs will work with the techniques discussed herein as long as there is sufficient light to obtain the desired purpose and no or minimal light that will have a deleterious effect.

Light intensity, or light flux, can be measured in watts or milliwatts per unit area, or can be measured in relation to an animal's visual spectral sensitivity, in units of Lux (Lumens/meter\hat{ }2), or alternatively cLux or Galli-lux in poultry, or foot-candles (Lumens/foot\hat{ }2). Lumens are a measurement of the light that is emitted from a light source in relation to human's spectral sensitivity. Light intensity changes (decreases) the further away from the light source that the measurement is taken. Thus, it is important to note the location of, or target for, a light intensity measurement. In general, bright light or high intensity light is light with an illuminance intensity in the range of 100 to 50,000 Galli-lux, or cLux. In general, dim light or low intensity is in the range of 0.1 to 20 Galli-lux, or cLux.

An egg production or other animal facility, such as a cage-free egg production facility, includes a set of enclosures. Each enclosure can be a room, a pen, a corral, a fenced area, a cage, or the like, which houses a group of animals. Animals are able to move within one enclosure, but are generally restricted from moving between different enclosures. Different areas or volumes within the enclosure can be designated for particular uses. For example, a feeding area can be designated around a feeder or other food source in the enclosure, and a watering area can be designated around a water source. Light sources, such as LEDs, lamps or bulbs, can be installed in or around the enclosure to illuminate different areas of the enclosure. In some examples, directional light sources are used to concentrate, focus, or contain the illumination from each light source within a particular area of the enclosure.

The light sources in the enclosure can produce light with different spectrums, so as to illuminate particular areas of the enclosure with different colored light. The color or spectrum of each light source can be selected so as to promote or encourage certain behaviors in particular areas of the enclosure, to hinder or discourage the same or other behaviors in other areas of the enclosure, or a combination of promoting or encouraging, and hindering or discouraging different behaviors. For example, a first light source having a spectrum selected so as to encourage feeding can be used to illuminate a feeding area of the enclosure Additionally, or alternatively, a second light source having a spectrum selected so as to encourage egg laying can be used to illuminate a nesting area of the enclosure. The color or spectrum of each light source can also be selected so as to promote or encourage certain behaviors at certain times, or to hinder or discourage these or other behaviors at other times. For example, a first light source having a spectrum selected so as to encourage feeding can be used to illuminate all or part of the enclosure at a feeding time (e.g., during a particular time period every day). Additionally, or alternatively, a second light source having a spectrum selected so as to discourage cannibalism at a late age can be used to illuminate all or part of the enclosure when the animals in the enclosure reach the late age.

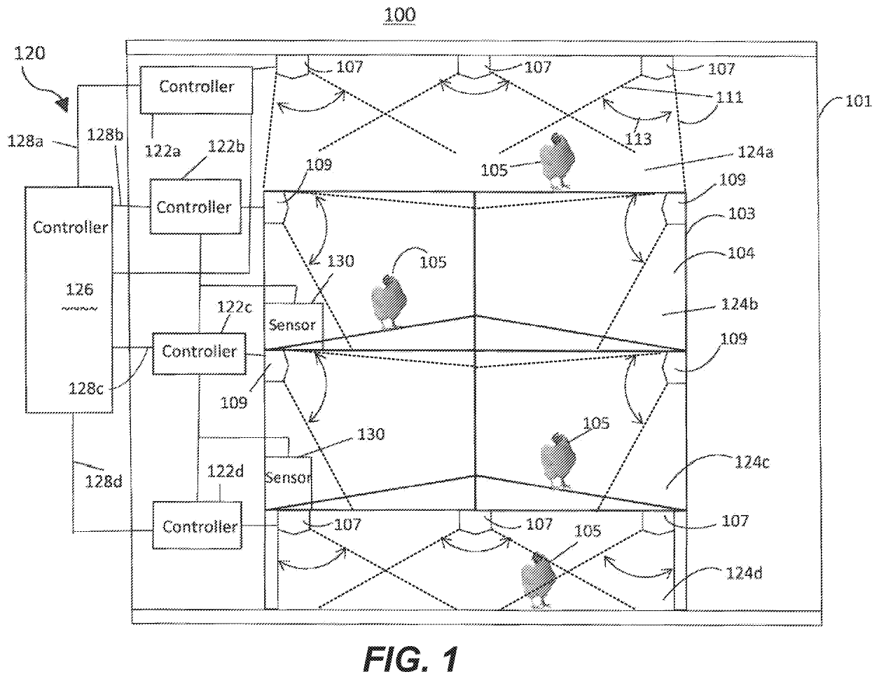

FIG. 1 shows a cross-sectional view of an enclosure 101 having a differential illumination system 100. The enclosure containing an aviary system 103 for housing animals. The enclosure 101 may be one of many enclosures included in an egg production facility. Each enclosure 101 houses a group of animals that can move within the enclosure, but are restricted from moving between different enclosures. The enclosure 101 includes one or more aviary systems 103 located within the enclosure. The chicken 105 or other avian species or animals housed in the enclosure 101 can move freely between the enclosure 101 and the aviary system 103 through one or more openings in the aviary system 103.

An aviary system 103 is a structure for housing chicken 105, other avian species or animals in an interior volume 104 thereof, and for providing various services to the chicken 105. The aviary system 103 can include supply lines, augers, and/or belt conveyors for conveying inputs to and outputs from the aviary system 103. For example, the aviary system 103 can supply feed, water, and/or light to the chicken, and can remove litter and recover eggs laid by the chicken. The interior volume 104 of the aviary system 103 can thus include different areas or systems designed or designated for different purposes. For example, the aviary system 103 can include a nest area for laying eggs, one or more feeding or drinking areas for providing food or water to the chicken 105, and one or more roosting areas, or the like.

The enclosure 101 can also include different areas or systems designed or designated for different purposes. For example, the enclosure 101 can include a scratching area, located for example on a floor of the enclosure 101 (e.g., a portion of the floor located underneath the aviary system 103, a portion of the floor located next to or around the aviary system, in an aisle between two or more aviary systems 103, or the like), on top of an aviary system 103 within the enclosure 101, outside of a barn in a case in which the enclosure 101 includes an outdoor section, or the like. The scratching area can be designed for use in scratching, pecking, and/or dust bathing. In some examples, the enclosure can additionally or alternatively include one or more perches or roosting areas separate from the aviary system 103.

First light sources 107 and second light sources 109 can be installed to provide illumination in the enclosure 101 and in the aviary system 103. The light sources (107, 109) may be incandescent bulbs, fluorescent lights, light-emitting diode (LED), or other suitable lamps. Each light source produces light with a particular spectrum or selection of radiation wavelengths. Each light source illuminates a designated area of the enclosure 101 and/or aviary system 103. In the example of FIG. 1, for instance, the light sources 107 are located in the enclosure 101 (but outside of the aviary system 103), and are located and oriented so as to illuminate areas located above the aviary system 103 and underneath the aviary system 103. In the example, the light sources 109 are located within the aviary system 103 (e.g., on each of two or more levels within the aviary system), and are located and oriented so as to illuminate areas located within the internal volume 104 of the aviary system 103.

In some examples, the light sources 107, 109 can be directional light sources. Directional light sources produce a directed beam 111 of light having a given width or angle 113 (e.g., a beam angle less than 60 degrees), and are designed to predominantly (or only) provide illumination in a given direction or location. In the example of FIG. 1, for instance, the directional light sources 107 are designed (and mounted and oriented) to concentrate their illumination on an upper surface above the aviary system 103, and in a floor region located underneath the aviary system 103, so as to minimize or avoid the illumination from the sources 107 from penetrating inside of the aviary system 103 (e.g., the light sources 107 are directed away from openings between the internal volume of the aviary system and the enclosure). Conversely, the directional light sources 109 are designed (and mounted and oriented) to concentrate their illumination within the aviary system 103, so as to minimize or avoid illumination from the sources 109 from penetrating outside of the aviary system 103 (e.g., the light sources 109 are directed away from openings between the internal volume of the aviary system and the enclosure).

Each light source 107, 109 produces light with a particular spectrum or selection of radiation wavelengths. As a result, one light source (or group of light sources) can produce light having one color or spectrum, while another light source (or group of light sources) can produce light having a different color or spectrum. Additionally, a single light source (or group of light sources) can selectively produce light having a different color or spectrum at different times (e.g., the light source can be controlled to produce light of one color now, and to produce light of a different color at another later time). The light sources 107, 109 can also be dimmable, such that the intensity of illumination produced by a light source can be selected or changed. Additionally, a single light source can selectively produce light having a different color at different dimming levels (e.g., the light can produce a white light at high lighting intensities, and a reddish light when dimmed to a lower lighting intensity). The color (or spectrum) and intensity of a group of multiple light sources can be controlled together: as such, all light sources 107 providing illumination outside of the aviary system 103 can be controlled together (such that they all provide a similar color and intensity of lighting), while all light sources 109 providing illumination inside of the aviary system 103 can be controlled together.

In one embodiment a control system 120 is provided that is configured to operate the light sources 107 and 109 including dimming and turning the light sources on for predetermined intervals and off at predetermined times. In one embodiment the control system 120 comprises one or more controllers 122 that operate the light sources 107. In one embodiment, individual controllers 122a, 122b, 122c, 122d are set up for light sources 107 and 109 in individual levels 124a, 124b, 124c, 124c of the aviary system. The one or more controllers 122a, 122b, 122c, 122d are configured to dynamically alter lighting patterns of the different levels 124a, 124b, 124c, 124d of the cage free aviary system 103. In particular, the controller can utilize any manner, feedback, feed forward, smart logic, proportional integral derivative (PID) or the like to control the lighting elements of the light sources 107 and 109. In one embodiment a separate controller 122a, 122b, 122c, 122d is provided for each level 124a, 124b, 124c, 124d of the cage free system and each acts as a slave to a master controller 126. In another embodiment a single master controller 126 is provided with separate channels 128a, 128b, 128c, 128d with each channel controlling the light sources 107 and 109 of a separate level 124a, 124b, 124c, 124d of the system.

In each embodiment, an algorithm is provided to provide secondary lighting selected to cause a predetermined response of the avian. In an embodiment the secondary light is ultraviolet lighting that attracts avian to a level or to a location. In another embodiment, the secondary light, such as blue light, bright light, or bright white light, discourages an avian from being on a predetermined level or at a location. The secondary lighting is only provided for a predetermined amount of time, and in an example for one hour, to encourage or discourage the behavior for that period. The one or more controllers 122 are configured to provide the same secondary light on a first level of the cage free system while the secondary light is off at a different level. In particular, the algorithm randomizes the predetermined periods on each level to encourage the movement of birds throughout the system and discourage the birds from clustering in a single location. Specifically, the predetermined period of one level may overlap or not overlap with the predetermined period of a different level. By dynamically changing or randomizing the secondary lighting on each level, the migration of nearly all of the birds to one particular level is minimized.

In addition, the controller 126 is in communication with, and in an example embodiment electrically connected to, an auxiliary device 130 of the aviary system 103. For example, in one embodiment the controller 126 is in communication with the egg conveyor sensor 130 that determines how many eggs are being laid on each level 124 (124a, 124b, 124c, 124d). The one or more controllers 122 or 126 are configured to receive this real-time information and utilize this information in its randomization algorithm to dynamically react to too many or too few eggs being laid on any one particular level. In this manner secondary lighting elements of light source 107 or 109 that encourage movement of avian to a level 124 is actuated to encourage avian to move from an overcrowded level. Otherwise, in another example, a secondary light that discourages or repels the avian can be turned on if too many avian reside on a given level.

The light sources 107 and 109 can thus be used to encourage (promote) or discourage certain behaviors of chicken located in the enclosure 101 and in the aviary system 103 by causing the light sources to produce light with different spectrums.

In a first example, the light sources 109 produce red light (e.g., substantially red or reddish light) having a higher red component than the light produced by the light sources 107, so as to encourage the animals to roost, feed, and/or lay eggs inside the aviary system 103. Conversely, the light sources 107 produce blue light (e.g., substantially blue or blueish light) having a higher blue component than the light produced by the light sources 109, so as to discourage the animals from roosting and laying eggs outside of the aviary system 103.

In a second example, the light sources 109 produce a substantially red light having a first intensity, and the light sources 107 produce a substantially blue light having a second intensity. In order to encourage the chicken to gather inside the aviary system at dusk, the light sources 109 can initially be dimmed to produce a substantially red light having a third intensity lower than the first intensity. As the light sources 109 are dimmed, the spectrum of the light sources can change so as to increase the relative intensity of red light within the spectrum. The intensity of the lighting from the light sources 107 can be sustained temporarily to encourage the chicken to move into the dimmed or darkened aviary system 103. The intensity of the lighting from the light sources 107 can be reduced only at a later time, for example when the chickens have had a chance to move into the aviary system 103 for the night.

In a third example, the light sources 109 produce a substantially red light having a first intensity, and the light sources 107 produce a substantially blue light having a second intensity. In order to encourage the chicken to move out of the aviary system 103 (e.g., to enable the aviary system 103 to be cleaned), the light sources 107 can transition to produce a substantially red light while the light sources 109 transition to produce a substantially blue light. The blue light produced by the light sources 109 inside of the aviary system 103 can encourage the chicken to move out of the aviary system 103, while the red light produced by the light sources 107 in the enclosure 101 can encourage the chicken to rest in the enclosure 101.

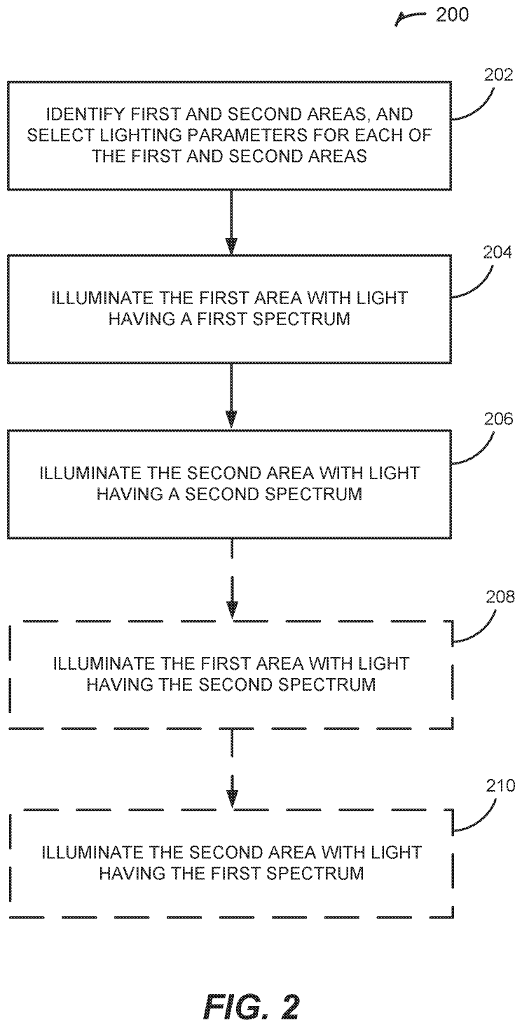

FIG. 2 is a flow chart illustrating a method 200 for controlling lighting and illumination, and in particular for providing differential illumination to control or affect animal behavior. The method 200 begins in operation 202 by identifying two or more areas in which to provide differential lighting. In one example, first and second areas may respectively correspond to an area forming part of an enclosure having an aviary system located therein, and an area forming part of an internal volume of the aviary system.

Operation 202 can further include selecting lighting parameters for each of the identified areas. Lighting parameters can include lighting state (on/off), lighting intensity, and lighting color or spectrum. The lighting parameters can be constant parameters, or time-varying parameters. For example, time-varying parameters can provide for variations in lighting intensity and/or color at different times of day, of week, of month, or of year. The time-varying parameters can further provide for variations in lighting intensity and/or color based on an age of animals in the enclosure or aviary system. In the example, light having a first spectrum can be selected for the first area, while light having a second spectrum different from the first spectrum can be selected for the second area.

In operations 204 and 206, the first and second areas are respectively illuminated with light having the first and second spectrums. In the example, the first area can be illuminated with light having a first spectrum having a higher red component than the second spectrum, while the second area can be illuminated with light having a second spectrum having a higher blue component than the first spectrum. Operations 204 and 206 can further include dimming or increasing the lighting intensity of the light in one or both of the areas. The dimming or increasing can be performed gradually over a period of time, or at random intervals.

Method 200 can optionally include one or both of operation 208 or operation 210. Operation 208 can include the first area is transitioned from being illuminated with light having the first spectrum to light having the second spectrum. Operation 210 can include the second area is transitioned from being illuminated with light having the second spectrum to light having the first spectrum. The changing of the spectrum composition of the lighting in one or both of the first and second areas in operations 208 and 210 may be performed non-synchronously, and at random intervals.

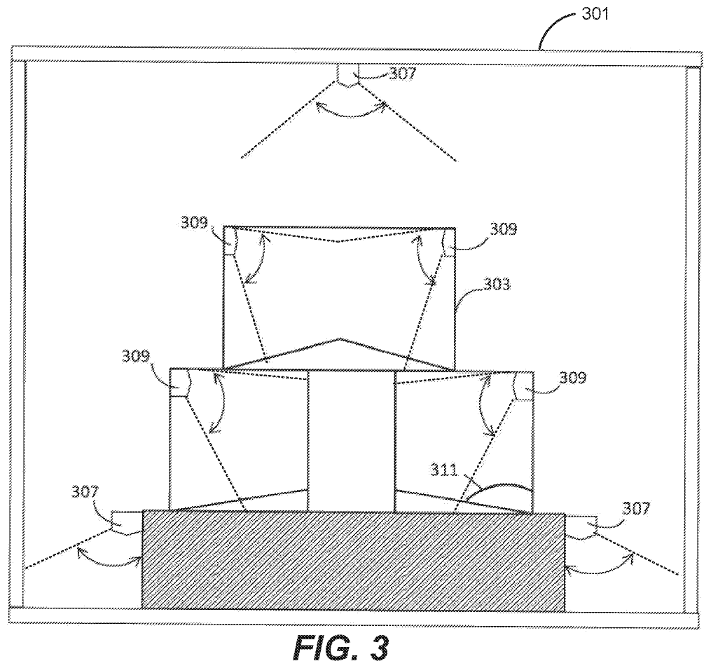

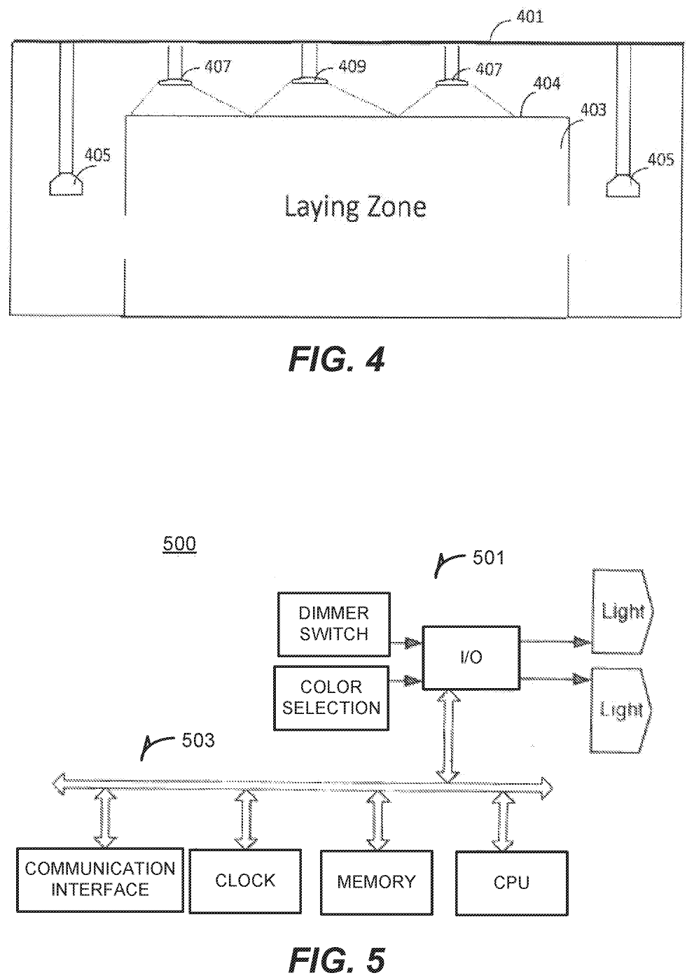

Method 200 can be performed, for example, in conjunction with an enclosure 101 having a differential illumination system 100 as depicted in FIG. 1 and discussed above, in a second enclosure 301 as depicted in FIG. 3, or of in a third enclosure 401 as depicted in FIG. 4, as discussed below.

FIG. 3 shows a cross-sectional view of a second enclosure 301 containing one or more aviary systems 303 for housing animals. In the example of FIG. 3, light sources 307 provide illumination having a first spectrum (e.g., a blue light spectrum) to at least some areas in the enclosure 301, such as areas located above or on top of the aviary system 303, and floor areas located next to or around the aviary system 303. This first spectrum could also be UV or UVA light. The first spectrum can be selected to substantially reduce or eliminate egg laying in the areas illuminated by the light sources 307. Light sources 309 provide illumination having a second spectrum (e.g., a red-light spectrum) to at least some areas within the aviary systems 303. The second spectrum can be selected to encourage or promote egg laying in the areas illuminated by the light sources 309. Some areas 311 within the aviary system 303 may receive substantially no illumination, or may receive no direct illumination from directional light sources 307 or 309.

FIG. 4 shows a cross-sectional view of a third enclosure 401 containing one or more egg laying zones 403. In the example shown, the enclosure 401 can correspond to an aviary system. The enclosure 401 includes various light sources 405, 407, and 409 that can each provide illumination having the same or different spectrums. For instance, light sources 405 can produce light with a first spectrum for encouraging scratching behavior, while light sources 407 and 409 can produce light with a second spectrum for encouraging roosting behavior. At least portions of the egg laying zone 403 can be surrounded by an opaque or substantially opaque barrier 404 which is used to limit the amount of illumination from the light sources 405, 407, and 409 which penetrates within the egg laying zone 403. The egg laying zone 403 may include one or more egg laying boxes for individual avian.

FIG. 5 shows a control system 500 for controlling lighting in an egg production facility having a differential illumination system, such as system 100. The control system 500 can include various manual controls 501 to enable the lighting state (on/off), lighting intensity, and lighting color or spectrum to be selected for one or more light sources. For example, the manual controls can include a dimmer switch or module, a color selection switch or module, and other switches or modules to control one or more light sources.

The control system 500 can additionally or alternatively include automated controls to manage the lighting state of light sources. A processing system 503 can perform partially automated or fully automated control of one or more light sources, and can include one or more processors or CPUs, one or more memories, a clock, and a communication interface (e.g., network interface, user interface, and/or the like). The memory can be a non-transitory machine readable medium storing machine-readable instructions for execution by the one or more processors, including instructions for selectively controlling light sources as described herein.

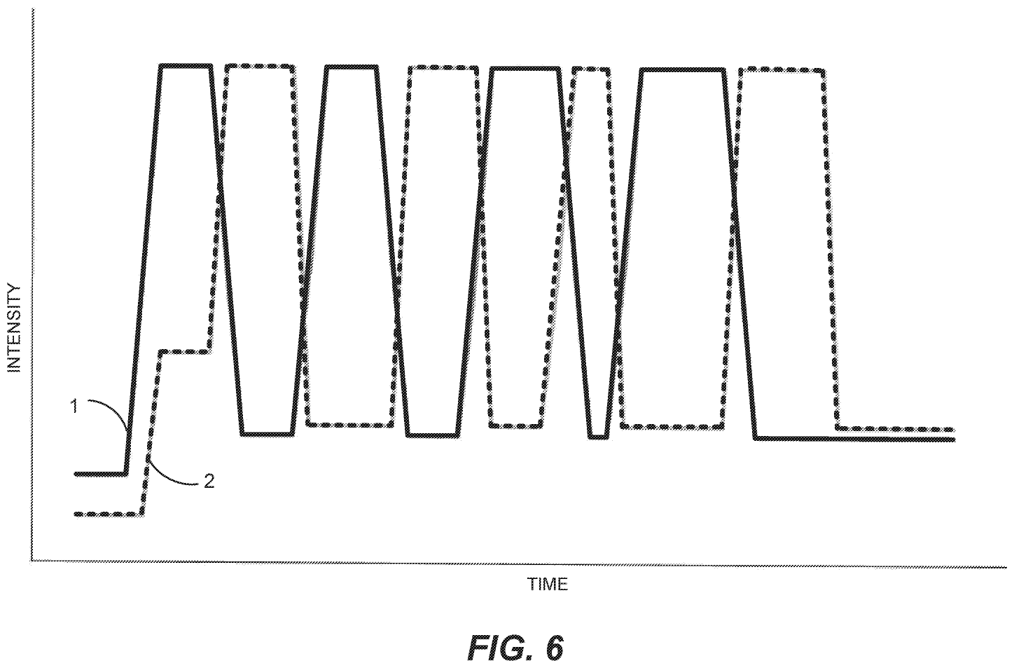

FIG. 6 is a graph of light source intensity over time with line 1 representing the light sources 107 or 109 at a first level 124a, 124b, 124c, or 124d while line 2 represents the other of light sources 107 or 109 at a second level 124a, 124b, 124c, or 124d. As shown, a gradual turn on occurs for both line 1 and line 2, but the intensity of line 1 decreases in a non-synchronous manner compared to line 2. In an example, while light sources 107 of a first level 124a, 124b, 124c, or 124d decrease in intensity, light sources 109 of a second level 124a, 124b, 124c, or 124d increase in intensity. In this manner the lighting schedules for each individual level are off-set from one another, encouraging movement of the birds to the different levels and preventing piling from occurring.

In another example, line 1 representing the light sources 107 at levels 124a and 124d while line 2 represents the light sources 109 at levels 124b and 124c. As shown, both line 1 and line 2, vary the intensity of light sources 107 and light sources 109 such that levels 124a and 124d, and levels 124b and 124c receive different intensities of light in a non-synchronous manner. In yet another example, light sources 107 and light sources 109 can include lamps or bulbs that can separately be activated to provide desirable or undesirable wavelengths or intensities of light, as perceived by the avian species. The desirable and undesirable wavelengths or intensities of light can be randomly alternated in different locations in an enclosure through the course of a day to encourage the avian species to move between different locations in the enclosure.

It has been reported that laying hens tend to get ‘bored’ and that pecking one another is a way to ease their boredom. A dynamic lighting system, where intensity and color of the light randomly and purposely changed, could serve as an alternative and reduce the aggression to other chickens. For example, ultraviolet light is known to attract avian species such as chickens. Avian species are also known to want to avoid bright light and blue light. Dim red light is used to encourage avian species to roost, lay eggs, or feed. A dynamic lighting system can be used to encourage chickens to move from one place to another. For example, if chickens are crowding or piling in one location, the intensity of the light could be increased or blue light could be emitted to the area to encourage the chickens to move to an area with dimmer light. By giving the chickens a reason to move around, pecking and other forms of aggression may be reduced.

Similarly, UV light is known to encourage avian species to feed. If parts of the feed or water system are crowded while other parts of the feed or water systems are being under used, UV light could be used in the area of the underutilized feed and water systems to encourage the avian species to move toward these systems. Alternatively, or in conjunction with the UV light, higher intensity light or blue light could be used at the over utilized feed and/or water stations to encourage the avian species to move along.

It is known that light flicker can affect avian species. For example, some animals and avian species find flicker under a rate of 100 Hz to be aversive. Some animals and avian species show enhanced activity when exposed to light flicker above 100 Hz. In an embodiment of the invention, low rate flicker could be used to discourage avian species from laying eggs where they shouldn't, such as on the ground under the egg nests. It could also be used to discourage piling or crowding in areas. Similarly, the high rate flicker could be used to draw avian species to a particular location such as an underutilized feed/water station or to areas away from where the avian species are bunched together.

While many embodiments of this disclosure are directed to egg laying avian species, many of the embodiments can be used for broiler systems (where avian species are raised for meat (protein source)). This invention can be applied to chickens and other avian species such as turkeys, ducks, quail, or geese.

For example, dynamic lighting systems can be used to encourage broilers to move around. By randomly using UV light to attract the broilers and either blue light or bright light to encourage broilers to leave a certain area, the lighting system can encourage movement from one location to another. Similarly, using UV light near underutilized feeders and/or waterers will encourage broilers to move toward these areas.

In roosting and egg laying locations, avian species seem to like to be on the highest location and tend to congregate next to vertical walls or dividers. The embodiments of this disclosure can be used to prevent over-crowding at these locations. For example, brighter lights can be used at the top locations of the roosts or egg laying facilities or next to walls and dividers so as to discourage the avian species from crowding at these locations. In addition, if other, less-used locations have dimmer light, the avian species can be encouraged to spread out.

On hot days when the ventilation system cannot sufficiently cool the avian barn, the birds can overheat and die. It may be desirable to lower or remove the red light from the ambient conditions so as to reduce activity in the barn.

For many of the example embodiments discussed herein, a control system as shown in FIG. 5 can be used to control the lights. If a facility has video monitoring of the facility, the operator can manually change the light color and intensity to alleviate problems as they arise. A more advanced system can have sensors that automatically sense when a problem is occurring and will automatically move to fix it. In a dynamic lighting system, it is preferable to randomly or pseudo-randomly change the lighting patterns so that the avian species does not become used to the changing light patterns.

A reference to an element in the singular is not intended to mean “one and only one” unless specifically so stated, but rather “one or more.” For example, a light source can refer to one or more light sources, an aviary system can refer to one or more aviary systems, a light or light spectrum can refer to one or more lights or light spectrums, a control signal can refer to one or more control signals, and a signal can refer to differential voltage signals. Unless specifically stated otherwise, the term “some” refers to one or more.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein can be considered to be at least equivalent.

In one aspect of the disclosure, when actions or functions are described as being performed by an item (e.g., producing, selecting, controlling, illuminating, determining, providing, generating, or any other action or function), it is understood that such actions or functions can be performed by the item directly or indirectly. In one aspect, when an element or module is described as performing an action, the element or module can be understood to perform the action directly. In one aspect, when an element or module is described as performing an action, the element or module can be understood to perform the action indirectly, for example, by facilitating, enabling or causing such an action.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

Terms such as “top,” “bottom,” “front,” “rear” and the like if used in this disclosure should be understood as referring to an arbitrary frame of reference, rather than to the ordinary gravitational frame of reference. Thus, a top surface, a bottom surface, a front surface, and a rear surface can extend upwardly, downwardly, diagonally, or horizontally in a gravitational frame of reference.

Various items may be arranged differently (e.g., arranged in a different order, or partitioned in a different way) all without departing from the scope of the subject technology.

It is understood that the specific order or hierarchy of steps, operations or processes disclosed is an illustration of exemplary approaches. Based upon design preferences, it is understood that the specific order or hierarchy of steps, operations or processes may be rearranged. Some of the steps, operations or processes can be performed simultaneously. Some or all of the steps, operations, or processes can be performed automatically, without the intervention of a user. The accompanying method claims present elements of the various steps, operations or processes in a sample order, and are not meant to be limited to the specific order or hierarchy presented.

The disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed.

1. A method for controlling an avian species comprising:
emitting a UV light in a first area of an enclosure, the UV light being desirable to the avian species; and
emitting a light having a wavelength undesirable to the avian species in a second area of the enclosure.

2. The method of claim 1 wherein the UV light is in a range of 340 nm to 430 nanometers (nm).

3. The method of claim 1 wherein the light having the wavelength undesirable to avian species has a light intensity in a range of 100 to 50,000 Galli-lux as experienced by the avian species.

4. The method of claim 1 wherein the light having the wavelength undesirable to avian species includes a blue light.

5. The method of claim 4 wherein the light having the wavelength undesirable to avian species is in a range of 430 nm to 500 nm.

6. The method of claim 1 further comprising:
non-synchronously alternating an intensity of the UV light and the light having the wavelength undesirable to the avian species in the second area of the enclosure.

7. The method of claim 1 further comprising:
emitting the light having the wavelength undesirable to the avian species in a third area of the enclosure; and
non-synchronously alternating an intensity of the light in the third area of the enclosure and an intensity of the light in the second area of the enclosure.

8. The method of claim 1 further comprising:
transitioning from emitting the UV light in the first area of the enclosure to emitting the UV light in a third area of the enclosure.

9. The method of claim 1 further comprising:
transitioning from emitting the light having the wavelength undesirable to the avian species in the second area of the enclosure to emitting the light having the wavelength undesirable to the avian species in a third area.

10. The method of claim 1 further comprising:
transitioning from emitting the UV light in the first area of the enclosure to emitting the UV light in the second area of the enclosure; and
transitioning from emitting the light having the wavelength undesirable to the avian species in the second area of the enclosure to emitting the light having the wavelength undesirable to the avian species in the first area;
wherein the transitions are performed at random times during a day.

11. The method of claim 1 further comprising:
emitting a red light in the first area or the second area.

12. A method for controlling egg laying avian species comprising:
emitting a low intensity red light near an egg laying zone;
shielding an interior area of the egg laying zone such that the low intensity red light is only minimally allowed inside the interior area of the egg laying zone; and
emitting a UV light in one or more areas where egg laying is not desired.

13. The method of claim 12 wherein the low intensity red light has a wavelength in a range of 600 to 700 nanometers (nm).

14. The method of claim 12 wherein the low intensity red light has a light intensity in a range of 0.1 to 20 Galli-lux as experienced by the egg laying avian species.

15. The method of claim 12 wherein UV light has a wavelength in a range of 350 to 400 nm.

16. The method of claim 12 wherein the UV light has a light intensity in a range of 5 to 100 Galli-lux as experienced by the avian species.

17. The method of claim 12 wherein the interior area of the egg laying zone includes egg laying boxes.

18. The method of claim 12 wherein the areas where egg laying is not desired includes on the floor and areas above the egg laying zone.

19. The method of claim 1 wherein the avian species is chicken, turkey, or duck.

20-21. (canceled)
